(19) United States
(12) Patent Application Publication
(10) Pub. No.: US 2009/0190090 A1
(43) Pub. Date: Jul. 30, 2009

(54) METHOD FOR FORMING SILICONE HYDROGEL CONTACT LENS AND STRUCTURE THEREOF

(76) Inventors: William HUNG, San Chung City (TW); Chih-Hun Chang, San Chung City (TW); Chih-Chin Lian, San Chung City (TW)

Correspondence Address: LEONG C LEI, PMB # 1008, 1867 YGNACIO VALLEY ROAD, WALNUT CREEK, CA, 94598, US

(21) Appl. No.: 12/020,589

(22) Filed: Jan. 28, 2008

(51) Int. Cl. G02C 7/04; B29D 11/00

(52) U.S. Cl. 351/160 H; 264/2.6

(57) ABSTRACT

A method for forming a silicone hydrogel contact lens is disclosed, wherein a lens body is formed by curing a mixture of silicone lens matrix, including a filling material, which is water soluble or organic solvent soluble. The lens body, once formed, is processed by water or organic solvent extraction to remove part or whole filling material from the silicone matrix of the lens body. Whereby densely distributed and interconnected pores are formed in the lens body to provide additional wettability required for the contract lens. This method is also applicable of to making other optical medical devices, such as an intraocular lens.

### BACKGROUND OF THE INVENTION

(a) Technical Field of the Invention

The present invention relates to a method for forming a silicone hydrogel contact lens and the structure of the contact lens formed with the method, and in particular to a method for making a silicone hydrogel contact lens that may allow for wearing of extended time without causing any eye disease or discomfort, as well as the structure of the contact lens so made.

(b) Description of the Prior Art

Due to the needs in the respects of aesthetics and convenience, contact lenses are getting popular recently. There are generally two categories of contact lenses, namely hard contact lenses and soft contact lenses, between which the soft contact lens is more comfortable in wearing. FIG. 1 of the attached drawings shows a conventional structure of contact lens, broadly designated at 10. To wear the conventional contact lens 10, the wearer inserts the contact lens 10 into his or her eye with the contact lens 10 located immediately in front of the eyeball 3. The contact lens 10 then serves to refract the light enters the eyeball to thereby correct the vision of the wearer. The contact lens 10 is tightly positioned on the surface of the eyeball, that prevents air from reaching the eyeball during the period in which the contact lens is worn. Lack of oxygen supply to the eye, may cause eye redness (expansion of eye capillary) of the contact lens wearer and thus extreme discomfort. In respect of this, it is of vital importance to the eye cells that the contact lens material has high oxygen permeability. Otherwise, wearing contact lens with extended period of time will eventually result in death of eye cells and causing eye diseases due to lacking of oxygen supplied to the cells.

The most common lens materials that are currently available for making soft contact lens include silicone and hydrogel, both having advantages and disadvantages. The hydrogel is a hydrophilic substance, but possesses only low oxygen permeability. Furthermore, hydrogel with high water content would lose part of water in a dry environment, causing discomfort to the wearer of the contact lens.

On the other hand, silicone material, which possessing excellent oxygen permeability, is hydrophobic, incapable of conveying nutrient fluid and expelling wastes. Furthermore, a contact lens made of a material that is not wettable, such as silicone, may undesirably suck to the eyeball, making it difficult to remove from the eye, and eventually damage the eye.

Therefore, polymeric silicone hydrogel materials become the material of choice for the new generation of contact lenses, as described in U.S. Pat. Nos. 4,136,250, 4,139,513, 4,153,641, 4,260,725, 4,711,943, 4,740,533, 4,910,277, 4,983,702, 5,034,461, 5,070,169, 5,070,215, 5,093,447, 5,260,000, 5,426,158, 5,710,302, 5,714,557, 5,726,733, 5,908,906, 5,959,117, 5,962,548, 6,367,929, 6,822,016, 6,849,671, 6,891,010, 7,052,131, and 7,098,282. Silicone hydrogel materials, have the advantages of both above materials mentioned. This is due to the fact that required macromers contained both silicone and hydrogel blocks, the silicone portion (or a fluorine contained silicone) provides high oxygen permeability, while the hydrogel portion provides the wettability, that facilitates fluid transport and lens movement. Unfortunately, the process of making this type of macromers are extreme difficult and thus costly. Since it is difficult to mix together two substances with totally opposite properties, while still maintaining optical clarity of the final mixture. It is just as difficult as mixing water with oil in an attempt to form a clear and completely light transparent film. The copolymerization of these monomers (or macromers) generally results in opaque, phase-separated materials.

Thus, notwithstanding the advances made to date, there still exists a need a new method to manufacture silicone hydrogel lens which possess a high degree of oxygen permeability and wettability. It may allow to use as extended wear contact lens without further surface treatment.

### SUMMARY OF THE INVENTION

The principal objective of the present invention is to provide a simple method for making silicone hydrogel contact lens, the simplified process would effectively reduces manufacturing costs and enhance market competitiveness.

Another objective of the present invention is to provide a silicone hydrogel contact lens that posses a high degree of oxygen permeability and wettability. It may allow to use as extended wear contact lens without further surface treatment.

In accordance with the present invention, a method for forming silicone hydrogel contact lens comprises a mixing step for mixing silicone lens material (matrix) with filling materials to form a uniform mixture, a lens forming step for curing the mixture to form a lens body, and an extracting step for removing part or whole filling materials to form the silicone hydrogel lens.

The lens body so made in accordance with the present invention comprises densely distributed and interconnected pores within the lens body and on surfaces of the lens body.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view of a contact lens;

FIG. 2 is a flow chart illustrating a method for forming a silicone hydrogel contact lens in accordance with the present invention; and

FIG. 3 is a schematic view illustrating an illustrative example of a contact lens made with the method of the present invention.

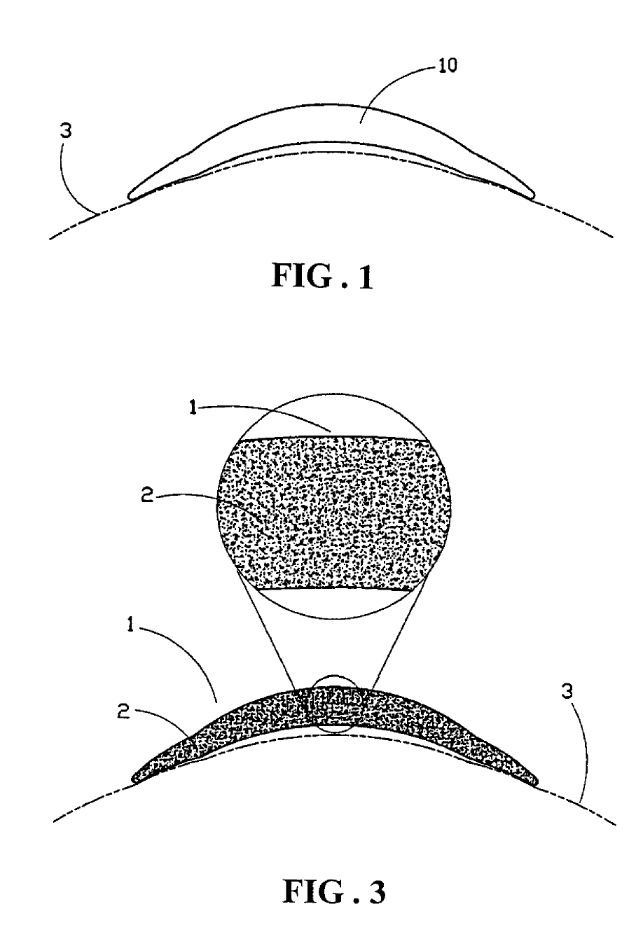

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

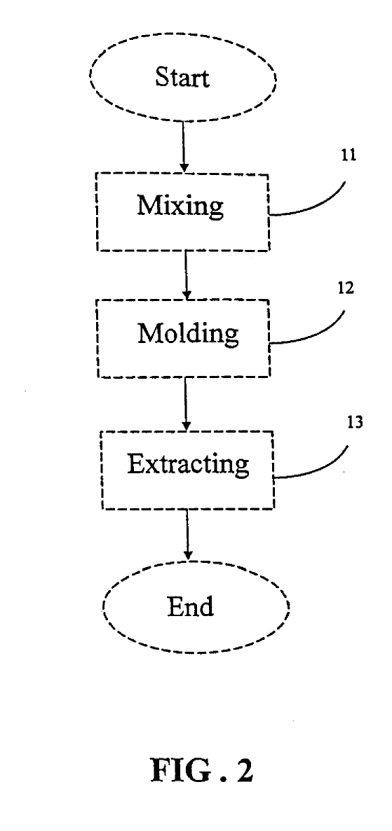

With reference to the drawings and in particular to FIGS. 2 and 3, the present invention provides a method for forming a silicone hydrogel contact lens and the method comprises a mixing step 11, a lens forming step 12, and an extracting step 13. The mixing step 11 mixes lens monomers (or macromers) with the filling materials. The filling materials are not polymerizable but water soluble, such as a water soluble (or organic solvent soluble) silicon-contained surfactant or a water soluble silicone, that selves as a filler, then mix with polymerizable silicone lens material to forma uniform mixture substance. In the lens forming step 12, the lens mixture is processed with standard polymerization methods to form a clear, soft, and resilient lens body 1. In the extracting step 13, the water soluble filling material is extracted or removed from the silicone matrix of the lens body 1. In this way, the lens body 1 is constituted with silicone hydrogel matrix and contain densely distributed and interconnected pores 2 inside the silicone hydrogel matrix. These pores can later be filled with saline solution or tear.

In accordance with the present invention, the silicone hydrogel contact lens is made by mixing a water soluble filling material with a silicone lens material to form the lens 1, then the water soluble filling material is removed from the lens matrix by simple water (or solvent) extraction to form the final product of the lens 1. Thus, in accordance with the present invention, plasma processing in not always necessary and there is no bottle neck in the manufacturing process in accordance with the present invention. As a result, manufacturing costs are reduced and market competitiveness is enhanced.

The polymerization process that the raw material of the contact lens in accordance with the present invention is subjected to for making the contact lens 1 can be any suitable polymerization process, such as thermal polymerization or UV (ultraviolet) radiation polymerization. Initiator for thermal polymerization of the present invention includes, but not limited to, lauroyl peroxide, isopropyl percarbonate, and azobisisobutyronitrile, which initiates polymerization process by generating free radicals in suitable high temperatures. On the other hand, initiators for photo polymerization applicable in the present invention include, but not limited to, aromatic alpha-hydroxyketone or tertiary amine with diketone.

Additives can be added into the lens material of the silicone hydrogel contact lens of the present invention, such as WV light absorbents and dyes. Other chemicals, such as mold release agent and wetting agent, can also be added to improve the manufacturing process of the contact lens.

### EXAMPLE 1

Following chemicals are mixed to form a clear solution, which will be referred as Chemical I:
methacryloxy propyl tris(trimethy siloxysilane) (TRIS) 47 parts;
methyl methacrylate (MMA) 8 parts;
N,N-dimethylacrylamide (DMAA) 42 parts;
hydroxyethylmethacrylate (HEMA) 2 parts;
ethylene glycol dimethacrylate (EGDMA) 1.5 parts; and
2,2′-azobis(2,4-dimethylvaleronitrile) (ADVN) 1 part.

The solution of Chemical I is filled into the contact lens mold and a standard thermal polymerization process is carried out to form the lens. After de-molding, the lens is socked in water overnight and then kept in saline. The lens so formed is optically clear, but the lens is rigid and hydrophobic, therefore it cannot be used as a soft contact lens.

On the other hand, when mixing 86.6% of Chemical I with 19.4% of Dow Corning 5329, a clear solution was resulted. A contact lens made with the same process as described in the EXAMPLE 1 above, is optically clear and hydrophilic. The contact lens so made has water content of around 29%.

### EXAMPLE 2

Following chemicals are mixed to form a clear solution, which will be referred as Chemical II:
methacryloxy propyl tris(trimethy siloxysilane) (TRIS) 45.5 parts;
methyl methacrylate (MMA) 8 parts;
N,N-dimethylacrylamide (DMAA) 32 parts;
1,1,1,3,3,3-hexafluoroisopropyl acrylate 10.5 parts;
ethylene glycol dimethacrylate (EGDMA) 4 parts; and
2,2′-azobis(2,4-dimethylvaleronitrile) (ADVN) 2.5 parts.
   A contact lens was made by carrying out the same process as described in the EXAMPLE 1 above with Chemical II, is optically clear, however the lens is rigid and hydrophobic, therefore it cannot be used as a soft contact lens.
   However, if a clear solution, hereinafter referred to as Chemical III, which is formed by uniformly mixing 4 parts of Chemical II with one part of Dow Corning 5329, is used to make a contact lens with the same process as described in the EXAMPLE 1 above, then the contact lens so made is optically clear and hydrophilic. The contact lens so made has water content of around 18%.

If desired, few drops of Blue-15 solution was added into the Chemical III to form a light bluish transparent liquid (IV) and such a light bluish liquid is used to form a contact lens with the same process as described in the EXAMPLE 1 above. The contact lens so made has a light bluish color. It is noted that Blue-15 solution mentioned above is a liquid formed by dispersing Blue-15 paste at a concentration of 5% in N,N-dimethylacrylamide.

Furthermore, by adding 2.2% 2-(4-benzoyl-3-hydroxyphenoxy) ethylacrylate into the above mentioned liquid IV, the resulting mixture is then used to make a contact lens with the same process as described in the EXAMPLE 1 above. The contact lens so made is optically clear and can block more than 90% UV radiation.

A process for making a colored cosmetic contact lens is as follows. The blue printing ink was prepared by mixing a proper amount of Blue-15 with Chemical II, then adding 5% of trimethylolpropane trimethacrylate to make the final mixture. The blue printing ink is first printed in a lens mold to form a desired pattern, then the coating was heated to half-cure. Chemical III is subsequently filled into the mold and the contact lens manufacturing process described in the EXAMPLE 1 above is followed to form the blue colored cosmetic contact lens.

### EXAMPLE 3

Following chemicals are mixed to form a clear solution, which will be referred as Chemical V:
methacryloxy propyl tris(trimethy siloxysilane) (TRIS) 46.5 parts;
methyl methacrylate (MMA) 8 parts;
N,N-dimethylacrylamide (DMAA) 30.5 parts;
1,1,1,3,3,3-hexafluoroisopropyl acrylate 10.5 parts;
ethylene glycol dimethacrylate (EGDMA) 4.5 parts;
2,2′-azobis(2,4-dimethylvaleronitrile) (ADVN) 2.5 parts; and
1,3-bis(3-methacryloxy propyl) tetrakis (trimethyl siloxy) disiloxane 1%.
   A contact lens was made by carrying out the same process as described in the EXAMPLE 1 above with Chemical V is optically clear, however, the lens is rigid and hydrophobic, therefore it cannot be used as a soft contact lens.

When mixing 4 parts of Chemical V with one part of Dow Coming 5329. The contact lens made with the same process as described in the EXAMPLE 1 above, is optically clear and hydrophilic. The contact lens so made has water content of around 18%.

To summarize, the silicone hydrogel contact lens in accordance with the present invention and manufacturing with the method provided herein allows to be used for extended wear. The method of the present invention also provides a low cost process for manufacturing silicone hydrogel contact lens, that enhances market competitiveness.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I We claim:

1. A method for forming a silicone hydrogel contact lens, comprising the following steps:
(1) a mixing step, for mixing silicone lens materials with a filling material to form a new lens material;
(2) a lens forming step, in which the new lens material is cured to form a lens body; and
(3) an extracting step, for removing part or whole filling material to form the silicone hydrogel lens.

2. The method as claimed in claim 1, wherein the lens forming step comprises employing a polymerization process to form the lens body.

3. The method as claimed in claim 1, wherein the filling material comprises water soluble silicone.

4. The method as claimed in claim 2, wherein the filling material comprises water soluble silicone.

5. The method as claimed in claim 1, wherein the filling material comprises a water soluble silicon-contained surfactant free of polymerizable groups.

6. The method as claimed in claim 2, wherein the filling material comprises a water soluble silicon-contained surfactant free of polymerizable groups.

7. The method as claimed in claim 3, wherein the filling material comprises a water soluble silicon-contained surfactant free of polymerizable groups.

8. The method as claimed in claim 1, wherein the filling material comprises an organic solvent soluble silicone free of polymerizable groups.

9. The method as claimed in claim 2, wherein the filling material comprises an organic solvent soluble silicone free of polymerizable groups.

10. The method as claimed in claim 3, wherein the filling material comprises an organic solvent soluble silicone free of polymerizable groups.

11. The method as claimed in claim 1, wherein the filling material comprises an organic-solvent-soluble silicon-contained surfactant free of polymerizable groups.

12. The method as claimed in claim 2, wherein the filling material comprises an organic-solvent-soluble silicon-contained surfactant free of polymerizable groups.

13. The method as claimed in claim 3, wherein the filling material comprises an organic-solvent-soluble silicon-contained surfactant free of polymerizable groups.

14. A silicone hydrogel contact lens comprising a lens body containing densely distributed and interconnected pores therein.
